(19) United States
(12) Patent Application Publication
(10) Pub. No.: US 2011/0121975 A1
(43) Pub. Date: May 26, 2011

(54) MOBILE SYSTEM FOR PROBATION RELEASE MONITORING PROGRAMS AND OTHER SECURITY-ORIENTED APPLICATIONS

(76) Inventors: Dale L. Dasher, Markleville, IN (US); Timothy R. Logue, Springport, IN (US); Andrew N. McDonald, Middletown, IN (US); Michael J. Mindal, Zionsville, IN (US)

(21) Appl. No.: 12/626,129

(22) Filed: Nov. 25, 2009

(51) Int. Cl. G08B 23/00

(52) U.S. Cl. 340/573.4

(57) ABSTRACT

A tracking system including a transceiver, an attachment system for connecting the transceiver to a wearer, a microprocessor periodically connected in wireless communication with the transceiver, and a database operationally connected to the microprocessor. The transceiver is operationally coupled to a GPS satellite system and generates sets of datapoint pairs, with each respective datapoint pair including a geographic location value and time value corresponding to when the geographic location value was measured. The transceiver from time to time communicates a set of datapoint pairs to the microprocessor for storage in the database, and the attachment system generates an alert signal if disengaged from the wearer.

### TECHNICAL FIELD

The present novel technology relates generally to systems and methods for monitoring, and more particularly, to a system and method for tracking an individual's compliance with a restricted movement confinement.

### BACKGROUND

It is often necessary to track the movements of an individual. For example, when an individual is forced, such as by a court order, physiological deterioration, or the like, into a restricted movement regiment, the individual is permitted limited transitory and non-transitory activities within limited areas and restricted times. The individual is considered in compliance if he stays within the limited areas within the prescribed times. An example of this is when a court grants a probationary release to a prisoner for as long as he obeys a prescribed schedule dictating both locational and time restrictions or his movements. In this example, the probationary released individual may be required to be in his home during the hours of 7 P.M. to 8 A.M., at work during the hours of 9 A.M to 6 P.M., and along a pre-defined route during the time it takes to get to work and back home. Further, some locations may be identified as always off limits.

Previously, the only means available to available to confirm the individual's compliance with the restricted times and locations was to receive some sort of signal through a land-line telephone at pre-arranged times. The signal could either be a call from the individual or a communication from a device worn by, or otherwise attached to, the individual. In either case, compliance was essentially defined as being within close proximity to a few known telephones at pre-defined times.

This system has several critical failures. First, such a system provides no transitory information. Also, the above described system requires the restricted individual to have access to a fixed location land-line telephone. Further, the above described system can only determine whether the sending unit (a device attached to the restricted individual) is within a predetermined number of feet of a base unit or not, and only at predetermined times. Because of the reliance on a land-line telephone, there is no possibility of receiving information about the restricted individual's course while that individual is moving from one location to another. Similarly, the usage of pre-defined times for the determination of compliance permits noncompliance during other times. Another similar, and much worse, problem is that the prior system provides no means of location a restricted individual who has chosen to ignore his restrictions.

Other problems, with the prior system include the inability to immediately alert authorities upon the unauthorized removal of the attached device from the restricted individual. Since the prior system requires a land-line fixed telephone through which it (the attached device) communicates at scheduled times to some central location, unauthorized removal of the device cannot be detected during non-scheduled communication times or when outside of the devices range to communicate with the telephone. This permits a “head start” to anyone who might decide to remove the attached device immediately after a check-in and make a run for it.

The land-line telephone itself also provides for various, easy-to-exploit shortcomings. One such shortcoming is the requirement of all restricted individuals to have residential phone service. Another shortcoming is the ready availability of call forwarding or like means of appearing to place a call from a location where the caller is not. The prior system utilizes the fixed nature of land-line telephones as a means of indicating location, but so long as the specific telephone seems to be responding, the prior system has no real knowledge of noncompliance. Similarly, any means of spoofing the particular telephone (fooling the phone system) will be interpreted as being a legitimate location.

Finally, previous tracking systems have no notion of providing prior warnings/information organized by particular restriction geography of the city/area in question. Additionally, previous systems provide no room for customization of restricted/permitted areas for the restricted individual. Because of this, there is currently no notion of restricted mobility based upon restriction or any ability to customize the restricted mobility for a particular restricted individual's unique situation.

Furthermore, prior tracking systems have failed to address various important limitations of the attached device. These limitations include a short power (charged battery) life and the inability to ensure compliance while/during power source replacement.

Finally, prior systems largely ignore the format and usefulness of the collected data. The prior systems do not provide for collecting the data into centralized databases, nor do the prior systems provide for color-coding and map display of the data for readability and/or evidence purposes.

There is therefore a need for a method and apparatus for a highly configurable and customizable mobile system for probation release monitoring programs and other security-oriented applications. The present novel technology addresses this need.

### SUMMARY

The present novel technology relates to a mobile tracking apparatus for probation release monitoring programs and other security-oriented applications, and a method for using the same. The novel technology also helps to enhance productivity of law enforcement and security personnel by reducing the need for officers to personally investigate and verify the movements of persons in restricted confinement situations. According to one aspect of the novel technology, a method of utilizing the informational and locational capabilities of the wearable apparatus is provided. The method typically includes uniquely identifying and locating the wearer based upon information provided by the apparatus. The information from the apparatus is collected, collated and then stored within a database. The frequency with which the information is collected, collated and stored is configurable. Less frequent communication provides prolonged power source life.

The apparatus itself typically consists of a relatively small, sealed, and tamper-resistant wireless device with a relatively long-lived power source. Without limitation, other suitable configurations, such as multiple small, sealed, and tamper resistant components are possible. Further configurations may include such anti-tamper mechanisms such as explosive cartridges containing blue dye and/or essential oils. Attached to the apparatus is strap or the like for securing the apparatus to the wearer. Through one of any number of means (physical resistance, electrical conductivity, biometrics, and the like), the apparatus can detect when the attaching strap has been compromised. While not existing in the current embodiment, the apparatus could be envisioned to be configured to sense the wearer's biometric information such as emotional status, heartbeat, blood pressure, and the like through the use of skin electrical resistance, moister content, sound, or the like. The apparatus is typically GPS enabled, more typically with a non-volatile memory with which it temporarily stores sampled information (GPS values, time of GPS sampling, apparatus state, and the like). Additionally, the apparatus typically has some form of identification that is unique to a specific apparatus. The typical implementation has unique identification in the form of a specific phone number. Upon communication, the stored information, along with identification, is uploaded to the afore-mentioned database.

Interaction between the apparatus and the means of collection, collation and storage is typically not limited to one-way. The apparatus itself can be contacted and ordered to immediately report desired information. Likewise, the apparatus may be ordered to alter various operating parameters.

Positional components of the wearer's collected information may then be compared to a customized set of geographic restrictions. The set of restrictions may include time restricted, customized restricted, event restricted, and/or category restricted geographic areas and combinations of the same. Category restricted areas consist of those areas and times which would naturally be restricted based upon some generic classification. For example, the areas of interest within a city would be categorized based upon the particular restriction associated with a particular wearer. For example, schools and parks may be categorized as restricted for pedophiles, while bars, nightclubs, and liquor stores may be restricted for alcoholics.

The positional information is then time indexed and displayed over an area-of-interest coded map. Violations are coded based upon the nature and/or severity of the violation. Non-violation events of note may also be coded based upon nearness to a violation. Further, this method of visually displaying the information also permits the identification of repeated near-violations. For example, a pedophile's repeated nearness to, but non-violation, of a school zone would be readily identifiable. This information may then be flagged for communication to the appropriate authorities. Positional information can also be queried and time indexed for other reasons or needs. For example, a listing of all movements of wearers' near a crime location may be generated.

Access to the chronological and positional information regarding a wearer's actions along with remote interaction with the device is typically internet enabled. Access is typically secured through a role-based authorization and identification logon system. Information and interaction is typically accessed and displayed through a browser-based interface. Other means of data access may likewise be provided for. Examples of interaction with the device include apparatus initialization, setting apparatus parameters, and initiate immediate response.

One object of the present novel technology is to provide an improved personal tracking system. Related objects and advantages of the present novel technology will be apparent from the following description.

### BRIEF DESCRIPTION OF THE DRAWINGS

FIG. 1 is a schematic process diagram of a first embodiment tracking system of the present novel technology.

FIG. 2 is a schematic process diagram of the functioning of a GPS transceiver for the tracking system of FIG. 1.

FIG. 3 is a perspective view of the transceiver portion of the tracking system of FIG. 1 as worn by a wearer.

### DETAILED DESCRIPTION

For the purposes of promoting an understanding of the principles of the novel technology, reference will now be made to the embodiment illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

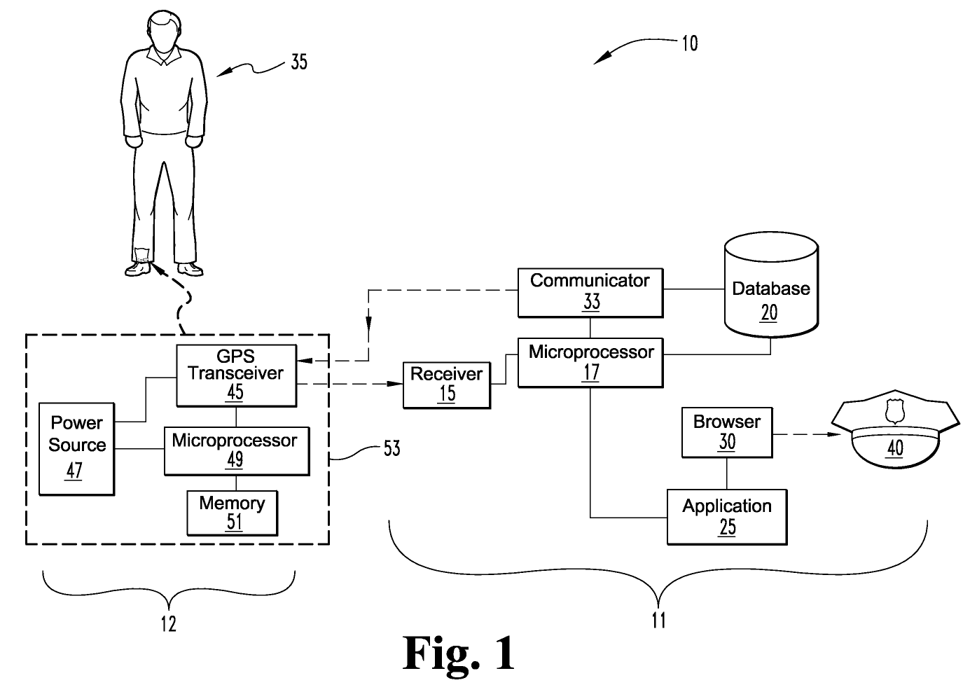

Referring to FIG. 1, there is illustrated a process flow of a tracking system 10 according to a first embodiment of the present novel technology. The system 10 typically includes server assembly 11 and remote transceiver assembly 12. Server assembly typically includes a receiver or transceiver 15, a database 20 operationally connected to the a communicator 33 for receiving and storing information from the remote transceiver assembly 12, various applications 25 for interaction with the database 20, a browser 30 for using the applications 25, a microprocessor 17 for housing (running) the various applications 25, the databases 20, and the browser 30 used for accessing the database 20 or applications 25. In some configurations, transceiver 15 also assumes the functions of communicator 33; in other configurations, receiver 15 is only configured to receive information from the remote transceiver assembly 12. Without limitation, examples of other equivalent configurations have the transceiver or receiver 15 replaced with a modem or receiver 15, respectively.

Remote transceiver assembly 12 typically includes a GPS enabled transceiver 45, a power source 47 connected to the transceiver 45 and also to a microprocessor 49, and a memory 51 connected to the microprocessor 49. Without limitation, it is understood that the GPS enabled transceiver 45 may be a unitary assembly or be a combination of a separate GPS enabled receiver and a separate transmitter and/or other suitable configurations. Transceiver 45, power source 47, microprocessor 49 and memory 51 are typically enclosed in a tamper resistant housing 53. Housing 53 is typically connected to wearer 35 by strap 37.

Typically the microprocessor 17 is connected to the communicator 33 for communication with the transceiver 45. The authorities 40 are charged with monitoring the movements of the wearer 35 of the transceiver 15. The authorities 40 may be the police, child welfare services, the wearer's family, doctors, mental health professionals, or the like, depending upon the wearer's situation. Typically, this monitoring is performed by the authorities 40 though the use of a browser 30 using the applications 25. In this example, the wearer 35 is a court-restricted individual, such as a convicted pedophile. However, the system 10 may alternately be used to track other wearer's 35 than released felons; for example, wearers 35 may include the very wealthy, those with diminished capacity and a tendency to wander off, children, the politically important, participants in social interaction experiments, and the like, and even animals or objects. Likewise, the exemplary model of how the system 10 works for tracking a restricted individual wearer 35 should not be taken to be representative as the only possible means of implementation.

While the example of FIG. 1 contemplates the transceiver 45 as a GPS enabled device capable of communicating via commercial wireless telephone systems, the transceiver 45 may be any convenient form of wireless communication. Additionally, while the example also contemplates an Internet web site through which access to the server assembly 11, and thus the remote transceiver assembly 12, is gained, the present novel technology also fully encompasses other means of communication, such as via a private network, an externally accessible intranet, other wireless and non-wireless telecommunications, or the like.

The system 10 provider acquires a GPS map of the area in question. The map is typically annotated with information about the various locations it contains; these annotations may be preloaded, or added by the system provider. For example, the set of locations within a school or school zone are noted as such. The set of GPS coordinates of the locations are then placed into various categories based upon their annotating values. For example, school zones may be categorized as off limits to pedophiles and/or drug offenders. The GPS locations and their respective annotation are then added to a database.

An individual of interest is selected or qualified for restricted movement and tracking, and thus becomes defined as the wearer 35. The wearer 35 information, including those categories identified as “prohibited” or “off limits”, is then entered into the database 20. The wearer's 35 special and/or customized restrictions and requirements are also entered into the database 20. Other information, such as regarding the identification of the relevant authorities 40, the various reports, alerts, apparatus state, and other desired to be automatically generated may also be entered at this time. Alternatively, such information may also be derived from previously set system defaults. An association between one of the tracking transceivers 15 and the so-identified restricted individual 35 is then formed.

The remote transceiver assembly 45 is then typically powered up, initialized with the various pertinent parameters (frequency of reporting and the like), firmly attached to the wearer 35, and typically tested for proper functioning. Note that there is no need for the various initialization activities to occur in any special location. Because the interface to interact with the system 10, and, ultimately the remote transceiver assembly 45 is through an (typically Internet enabled) application 35, the various initialization activities performed on the remote transceiver assembly 45 can be performed anywhere where there is communication means 33 access. For example, the remote transceiver assembly 45 could be initialized, tested and, attached to the wearer 35 at his home instead of at a police office. After initialization, the remote transceiver assembly 45 periodically wirelessly communicates with the database 20 to allow for transfer of data thereto regarding locations and remote transceiver assembly 45 state (i.e., verification that the remote transceiver assembly 45 is still functioning and properly connected to the wearer 35).

At prescheduled time, remote transceiver assembly 45 will require its power source 47 to be replenished. Alternatively, the remote transceiver assembly 45 may transmit a “low power” signal indicative of the need to have its power source 47 replenished. To do so, the wearer 35 may be required to report to a pre-determined location. Typically, a servicing individual would log into the system 10 and inform the system 10 that he will be performing service upon the specified remote transceiver assembly 45. The remote transceiver assembly 45 typically wirelessly communicates the information it has gathered since its last automatic notification to the database 20. The servicing individual is then typically granted a limited time in which to service the remote transceiver assembly 45. The system 10 typically reports a system-wide alert and notification should the designated remote transceiver assembly 45 not be initialized and report back before the expiration of the limited time period. A similar system-wide alert and notification might typically occur when the remote transceiver assembly 45 is violated. In this case, the only difference is that the remote transceiver assembly 45 continuously communicates its GPS and status information.

Users of the system 10 will be able to log in and visually inspect the movements of wearer 35. Additionally, users of the system 10 may also receive regularly scheduled emails, reports, and/or the like concerning the movements of wearer 35. This likewise may be accomplished over the Internet or like communication system 33 using a browser 30. The wearer's 35 movements may be color coded and displayed on an output, such as a map. Various elements of the map, based upon their categorization, may also be color coded for display on the map. The color coding can be used to denote various pieces of information. Examples of color coding may include coloring a restricted individual's movements in red when such movements are in violation of his restrictions, yellow when he is near to violating his restrictions, and green when he is within his authorized movement parameters. Alternatively, the information may be organized and presented in any convenient format.

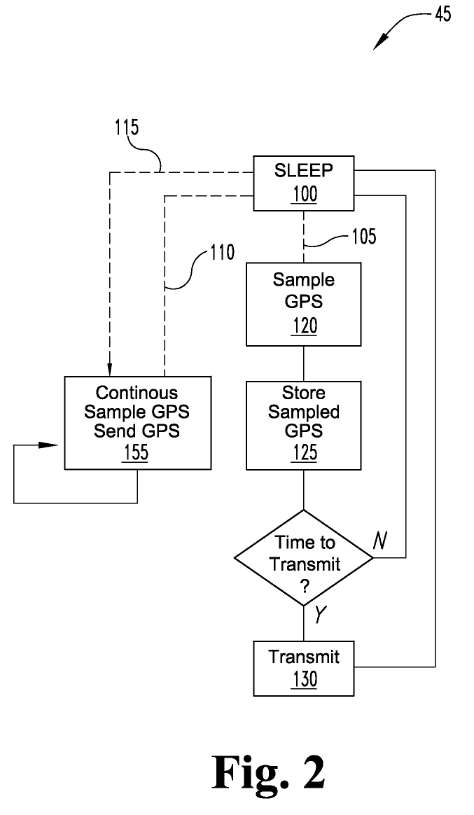

FIG. 2 is an idealized process or state flow chart of the system functions. The default state of the remote transceiver assembly 45 is its sleep state (100), a low power consumption state usually exited 105 through prompting by a timer at regular intervals or predetermined times. Other exit conditions may include detected tampering 110 with the transceiver 15 or receiving an alarm signal 115. The result of either being to enter into a state 155 that continuously samples GPS, assigns a time value to each respective sampled GPS value, and transmits the GPS/time value pairs. When exited under the usual conditions (timer event), the device 12 samples GPS and status information 120, stores that information 125, and transmits stored information 130 if it is also time to do so. The other exit conditions 110 may lead to the device continuously transmitting its GPS and status information, if it is so programmed.

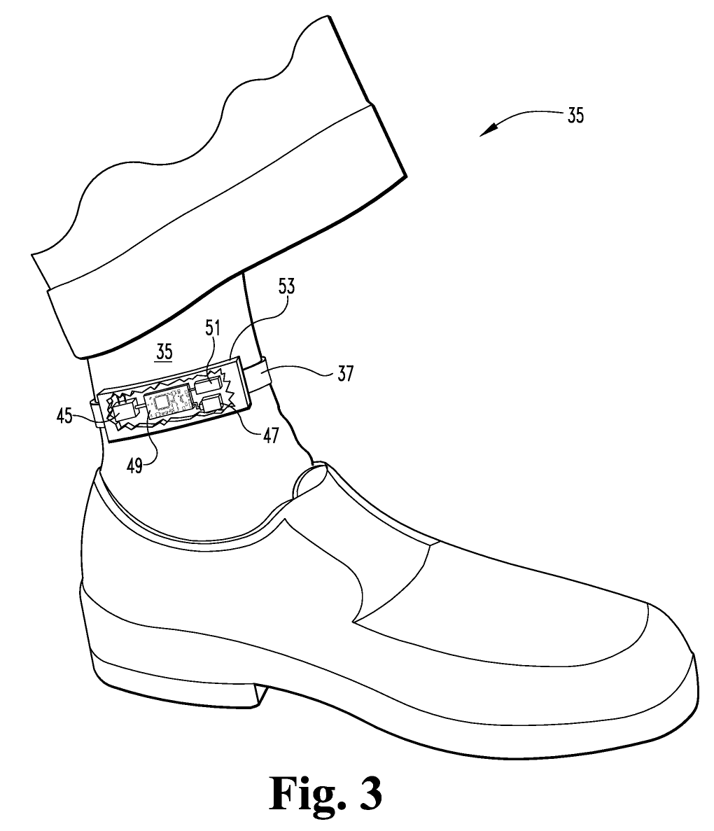

Referring to FIG. 3, there is illustrated a perspective view of wireless and GPS enabled remote transceiver assembly 45 as worn by wearer 35, according to a first embodiment of the present novel technology. Although the GPS enabled remote transceiver assembly 45 is depicted herein as one self contained unit, it is understood that the GPS remote transceiver assembly 45 could be composed of a separate GPS unit and a transceiver assembly or any other suitable configuration. In this depiction, the remote transceiver assembly 45 is attached to a strap 37 by which the remote transceiver assembly 45 is attached to the wearer 35.

The example of FIG. 3 contemplates a strap, band, bracelet, or the like as the attachment means 37 for connecting the remote transceiver assembly 45 to the wearer 35. The remote transceiver assembly 45 may also be fixed to the wearer 35 via other means. Other possible examples of means by which the remote transceiver assembly 45 may be fixed to the wearer 35 include oral placement (swallowing), surgical placement, riveting (piercing/stapling), and the like.

The remote transceiver assembly 45, its strap or like means of securing itself to the wearer 37, and the integrity of the remote transceiver assembly's 45 ultimate union to the wearer 35 via strap 37 are all typically tamper resistant. The remote transceiver assembly 45 is typically able to sense when it, the strap 37 and/or the ultimate union of the remote transceiver assembly 45 to the wearer 35 has been tampered with, such as through a change in electrical resistance or the like.

In operation, the functioning of the system 10 can be described as consisting of a plurality of non-mutually exclusive phases 220 that may be potentially active during the functioning of the system 10. The phases 220 are authority setup 225, map information 230, individual information 235, configuration 240, tracking 245, review 250, and servicing 255. The authority setup 225 phase is characterized by the creation of logins for and training of authority 40 (observers) of the system 10.

The map information phase 230 is characterized by either the database 20 already being populated with or the populating of the database 20 with the GPS map of the area in question. Typically, additional information is supplied to the database 20, annotating the various locations the map contains. Annotations may occur at any time and even be ongoing. They may also be preloaded or added by the system provider. Continuing the previous example of the set of locations within a school zone being noted as such, further annotation could include school building, school playground, and park next to a school (for a park location next to a school).

Associations between the GPS coordinates of the locations and categorization values are then formed within the database 20. Categorization values may either be preloaded or added by the system provider. Categorization values are based upon location annotating values. As previously stated, school zones could be categorized as off limits to pedophiles and/or drug offenders. A product of the map information phase is typically the population of the database 20 with a map of the area in question with its GPS coordinates annotated with location information and the coordinates being categorized based upon those annotating values.

Finally, the map information 230 phase is typically considered to be continuing. This is because some portion of the authorities 40, through the use of a browser 30 to make use of applications 25, may be able to add to the information contained within the database 20.

The individual information 235 phase is characterized by the population of the database 20 with the pertinent information of the wearer 35. As previously stated, the information includes “prohibited” or “off limits” categories. Additional information includes the wearer's 35 special and/or customized restrictions and requirements and to what authorities 40 the various reports, alerts, apparatus state, and other automatically generated information are sent to. At this time, an association between one of the tracking remote transceiver assemblies 45 and the so-identified wearer 35 is formed within the database 20. Similar to the map information 230 phase, this phase is also typically accomplished through the use of a browser 30 to make use of applications 25, running on microprocessor 17, adding to the information within the database 20.

The configuration 240 phase is characterized by the initialization and activation of the remote transceiver assembly 45. An authority 40, using an application 25 via a browser 30, optionally configures (initializes) the remote transceiver assembly 45 with custom parameters. An example of a custom parameter includes the frequency that the remote transceiver assembly 45 will transmit information. The remote transceiver assembly 45 is fixed to the wearer 35, in this example via a strap 7. An authority 40, typically using an application 25, then activates the transceiver 15.

In the tracking phase 245, the remote transceiver assembly 45 is typically in a sleep state 100, a low energy consumption state. Periodically (based upon a parameter optionally configured in the configuration phase) the remote transceiver assembly 45 will wake up from the sleep state 100, sample the GPS coordinates and state (conditions 120) of the remote transceiver assembly 45. The remote transceiver assembly 45 will then either store 175 the sampled information or transmit 130 all the stored information it has acquired since the last transmission. During transmission, the remote transceiver assembly 45 will wirelessly transmit the information to the system 10 via the communicator 33. Additionally and without limitation, while the communicator 33 is depicted as receiving the wirelessly transmitted information, it is to be understood that other suitable configurations are possible. For example, the communicator 33 could possibly include wired, fiber optic, and other non-wireless telecommunication technologies.

The periodicity of the transmission is another parameter optionally configured during the configuration phase 240. Alternatively, the remote transceiver assembly 45 may be woken from the sleep state by either a received command transmitted by the system 10 through the communicator 33 or through the detection tampering with the remote transceiver assembly 45 or with the strap 37. In either case, the transceiver 15 immediately samples and transmits the GPS coordinates 120 and may go into a constant transmission state where it continuously samples the GPS coordinates 120 and state information and transmits 125 them to the system 10. The periodicity of transmission is also observed by the system 10. In one configuration, should the system 10 fail to receive the remote transceiver assembly's 45 transmission 130 all the stored information it has acquired since its last transmission at the expected time, the system 10 will go into an alert stage where it will notify the authorities 40. The system 10 may also be configured to frequently attempt to command the remote transceiver assembly 45 through the communicator 33 to enter into a constant transmission state where it continuously samples the GPS coordinates 120 and state information and transmits 125 them to the system 10. The review 250 phase consists of two separate components. The first of which is the visual representation of the wearer's 35 movements over a window of time. An authority 40, using a browser 30 accesses an application 25 that depicts the wearer's 35 movements within a chosen time period over a map of the area. Without limitation, it is understood that the means of depiction of the wearer's 35 movements may take other forms. For example, a printed representation of the GPS map with the wearer's 35 movements could be used instead of a browser based visual representation. Typically, elements of the map and the tracked movements of the wearer 35 are color coded denoting additional information.

Another component is the reports, emails, and notices the system 10 conveys to the authorities 40. The reports, emails, and notices contain, among other information, listings of wearer 35 violations of his restrictions.

Additionally, there is the servicing 255 phase. It is during the servicing 255 phase where an authority 40 using a browser 30 accesses an application 25 to inform the system 10 of the need to service the remote transceiver assembly 45. The system 10 then accepts a limited time duration during which no transmissions are expected from the remote transceiver assembly 45. It is during this time that adjustments to the attachment of the remote transceiver assembly 45 to the wearer 35 can be made as well as any servicing to the remote transceiver assembly's 45 power source 47.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

What is claimed is:

1. A system for obtaining the location and travel history of a person, animal or object comprising;
a microprocessor assembly, and further comprising:
a microprocessor;
a memory operationally connected to the microprocessor;
at least one database operationally connected to the microprocessor;
at least one programmed application set operationally connected to the microprocessor;
an identification application operationally connected to the microprocessor;
an authorization application operationally connected to the microprocessor;
a first transceiver operationally connected to the microprocessor; and
at least one network interface operationally connected to the microprocessor;
wherein the at least one database, the at least one programmed application set, and the first wireless transceiver are accessible through the at least one network interface; and
an remote transceiver assembly, and further comprising:
a housing;
a second transceiver positioned in the housing;
a power source positioned in the housing and operationally connected to the second transceiver;
attachment means operationally connected to the housing;
a second microprocessor positioned in the housing and operationally connected to the second transceiver and operationally connected power source;
a second memory operationally connected to the second microprocessor;
sensor means for detecting tampering with the remote transceiver assembly operationally connected to the microprocessor;
wherein the microprocessor includes an internal timer; and
wherein the remote transceiver assembly is operationally connected to a GPS satellite system;
wherein the remote transceiver assembly from time to time measures GPS coordinates and the current time for storage in memory; and
wherein the remote transceiver assembly communicates stored GPS coordinates and time data to the microprocessor assembly via the wireless transceiver.

2. The system of claim 1, wherein the means of attachment of the apparatus is a strap.

3. The system of claim 1, wherein the means of attachment of the apparatus is an adhesive.

4. The system of claim 1, wherein the means of attachment of the apparatus is physical insertion into a wearer.

5. The system of claim 1, wherein the at least one programmed application set includes at least one application that permits identified and authorized users to issue system commands and to receive information.

6. The system of claim 1, wherein the at least one programmed application set includes at least one application that receives and processes apparatus information via the computer system's wireless transceiver.

7. The system of claim 1, wherein the at least one programmed application set includes at least one application that processes information in the database.

8. A method for electronically tracking and displaying the location and travel history of a wearer, comprising the steps of:
a) providing a microprocessor assembly having:
a microprocessor;
a memory operationally connected to the microprocessor;
at least one database operationally connected to the microprocessor;
at least one programmed application set operationally connected to the microprocessor;
an identification application operationally connected to the microprocessor;
an authorization application operationally connected to the microprocessor;
a first wireless transceiver operationally connected to the microprocessor; and
at least one network interface operationally connected to the microprocessor;
b) creating a GPS enabled map of an area in which the wearer will be permitted to roam;
c) creating the wearer-specific restrictions;
d) attaching a remote transceiver assembly to the wearer, wherein the remote transceiver assembly includes:
a housing;
a second transceiver positioned in the housing;
a power source positioned in the housing and operationally connected to the second transceiver;
attachment means operationally connected to the housing;
a second microprocessor positioned in the housing and operationally connected to the second transceiver and operationally connected power source;
a second memory operationally connected to the second microprocessor;
sensor means for detecting tampering with the remote transceiver assembly operationally connected to the microprocessor;
wherein the microprocessor includes an internal timer; and
wherein the transceiver is operationally connected to a GPS satellite system;
wherein the remote transceiver from time to time assembly measures GPS coordinates and the current time for storage in memory; and
wherein the remote transceiver assembly has a default low energy sleep state; and
e) engaging the remote transceiver assembly to exit the low energy sleep state and sampling GPS coordinates and the current time;
f) storing GPS coordinate/time data pairs into memory;
g) engaging the remote transceiver assembly to exits the low energy sleep state to wirelessly communicate the stored GPS coordinates/time data pairs to the microprocessor assembly;
h) creating movement reports of the wearer;
i) creating a violation report if the wearer roams beyond the map of the area in which the wearer will be permitted to roam; and
j) creating enhanced representations of the travel history of the wearer
wherein upon detection of tampering the remote transceiver assembly sends a tamper signal to the microprocessor assembly and commences continuous sampling of GPS coordinates and current time data for storage and transmission to the microprocessor assembly.

9. The method of claim 8 wherein the programmed application set includes at least one application that permits identified and authorized users to issue system commands and to receive information.

10. The method of claim 8 wherein the programmed application set includes at least one application that receives and processes apparatus information via the computer system's wireless transceiver.

11. The method of claim 8 wherein the programmed application set includes at least one application that processes information in the database.

12. The method according to claim 8 and further comprising:
k) after (a) and before (b), creating user ids for the identification and authorization component.

13. The method according to claim 8 and further comprising:
l) after (b) and before (c), annotating the GPS coordinates of the GPS enabled map with what landmarks the GSP coordinates generally correspond;
m) categorizing the GPS coordinates into prohibited restriction categories;
n) determining times for which the prohibited restriction categories are in effect;
o) storing the annotated and categorized GPS coordinates along with the associated prohibited times into the database; and
p) entering which prohibited restriction categories apply to the wearer into the database.

14. The method according to claim 8 and further comprising:
q) after (c) and before (d), determining GPS coordinates of the wearer-specific restrictions;
r) determining times for which the wearer-specific restrictions are in effect;
s) entering the GPS coordinates and the associated times of the wearer-specific restrictions into the database.

15. The method according to claim 8 and further comprising:
t) after (d) and before (e), forming an association between the apparatus and the wearer in the database;
u) configuring the remote transceiver assembly with a desired frequency of sampling of the GPS coordinates and apparatus status;
v) storing the sampled GPS coordinates and status in the second memory;
w) configuring the remote transceiver assembly with a desired frequency of wirelessly communicating the stored GPS coordinates/time data pairs to the microprocessor assembly;
x) activating the remote transceiver assembly; and
y) storing the GPS coordinate/time data pairs in the database.

16. The method according to claim 9 and further comprising:
z) after (e) and before (f), retrieving the prohibited restriction categories applicable to the restricted individual, animal, or object from the database;
aa) retrieving the wearer-specific restrictions from the database;
bb) retrieving the wearer's sampled GPS coordinate/time data pairs from the database;
cc) computing violations and proximities for the sampled GPS coordinates over the applicable restricted categories and the specific restrictions;
dd) storing the violations and the proximities in the database.

17. The method according to claim 9 and further comprising:
ee) after (f), retrieving the violations, the proximities, and the sampled GPS coordinates from the database;
ff) applying informational representation enhancements to the representations of the violations, the proximities and the sampled GPS coordinates.

18. A tracking system, comprising:
a transceiver assembly;
an attachment system for connecting the transceiver assembly to a wearer;
a microprocessor periodically connected in wireless communication with the transceiver assembly;
a database operationally connected to the microprocessor;
wherein the transceiver assembly is operationally coupled to a GPS satellite system;
wherein the transceiver assembly generates sets of datapoint pairs;
wherein each respective datapoint pair includes a geographic location value and time value corresponding to when the geographic location value was measured;
wherein the transceiver assembly from time to time communicates a set of datapoint pairs to the microprocessor for storage in the database; and
wherein the attachment system generates an alert signal if disengaged from the wearer.
